(19) United States
(12) Patent Application Publication
(10) Pub. No.: US 2011/0307310 A1
(43) Pub. Date: Dec. 15, 2011

(54) METHOD AND APPARATUS FOR RECEIVING UNSOLICITED CONTENT

(75) Inventor: Ajit Kamat, London (GB)

(73) Assignee: NOKIA CORPORATION, Espoo (FI)

(21) Appl. No.: 13/121,661

(22) PCT Filed: Sep. 28, 2009
(86) PCT No.: PCT/IB2009/054237

§ 371 Date: Jul. 19, 2011

(30) Foreign Application Priority Data
Sep. 29, 2008 (GB) 0817805.5

(51) Int. Cl. G06Q 30/00

(52) U.S. Cl. 705/14.4

(57) ABSTRACT

One embodiment is concerned with the receipt of unsolicited content, such as advertisement messages, but also including other data, such as network control data, warning messages, or the like, at an apparatus, and also how such unsolicited content is displayed to the user of the apparatus. For example, the unsolicited content may be combined with or replace an image being displayed. Here, a dedicated logical channel is provided for the communication of unsolicited content, and which terminates within the apparatus at a module provided for the task in the apparatus operating system. The channel links into the operating system of the apparatus, rather than a receiving application, as the OS is trusted, and can control other applications miming on the apparatus to accommodate the received advert. For example, the operating system can change the display of other applications that are running on the apparatus, to provide display space for a received advert. Another embodiment relates to how received unsolicited content is combined and displayed on the display of the apparatus. In particular, the existing display is adapted by shrinking the display in one or both of the horizontal and/or vertical directions, so as to make room for the received content. In this way, both the received content and the existing display can be combined and shown simultaneously, without one obscuring the other.

### TECHNICAL FIELD

The present invention relates to a method and apparatus for receiving unsolicited content, and in some examples it relates particularly to graphical content.

### BACKGROUND TO THE INVENTION

Mobile computing and communications apparatuses such as smartphones are becoming ubiquitous, both in the developed and developing world. They each provide a personal communications channel to each user. It is of little surprise, therefore, that such a channel is beginning to be exploited for marketing purposes, particularly by sending unsolicited content to such apparatuses, for example advertisements and the like. Advertisement messages may be received at a mobile apparatus using various messaging protocols, such as SMS, MMS, as Bluetooth messages or as email. Often, such messages received via such means are simply ignored by the user. It is therefore desirable to develop techniques which increase the visibility of such advertisements.

### SUMMARY OF THE INVENTION

A first example of the invention provides a method, comprising:
receiving at an apparatus, over a logical data channel dedicated to the provision of unsolicited content, data packets containing unsolicited content for reproduction by the apparatus;
processing the received data packets in an operating system of the apparatus, to retrieve the unsolicited content therefrom; and
combining or replacing, using the operating system, content that is presently being reproduced by the apparatus with the unsolicited content.

In an example, the unsolicited content is audio content and/or visual content. In another example, in the case where the unsolicited content is visual content, presently reproduced visual content is adapted to accommodate the unsolicited visual content such that the present visual content and the unsolicited visual content are combined to be displayable simultaneously. In a further example, the adaptation comprises reducing the size of the presently reproduced visual content so as to make room for the unsolicited visual content when combined therewith. In another further example, the presently reproduced content is reduced in size in one dimension, whilst retaining its original size in an orthogonal dimension.

A second example of the invention provides a method, comprising:
receiving at an apparatus unsolicited graphical content for display;
adapting an existing graphical display so as to reduce the size of the display; and
combining the adapted existing display and the received unsolicited graphical content such that they do not substantially overlap.

In an example, the existing graphical display is adapted in dependence on the size of the received unsolicited graphical content. In another example, the existing graphical display is adapted in dependence on the intended position of the received unsolicited graphical content. In a further example, the existing graphical display is adapted in dependence on the intended orientation of the received unsolicited graphical content.

In an example, the unsolicited graphical content is accompanied by meta-data relating to the intended display properties of the unsolicited graphical content.

In an example, the adapted existing display and the received unsolicited graphical content are combined such that they are contiguous when displayed together.

A third example of the invention provides an apparatus, comprising:
at least one processor; and
at least one memory including computer program code
the at least one memory and the computer program code configured to, with the at least one processor, cause the apparatus to perform at least the following:
receive at an apparatus, over a logical data channel dedicated to the provision of unsolicited content, data packets containing unsolicited content for reproduction by the apparatus;
process the received data packets in an operating system of the apparatus, to retrieve the unsolicited content therefrom; and
combine or replace, using the operating system, content that is presently being reproduced by the apparatus with the unsolicited content. Within the third example the same further features may be employed, as described above in respect of the first example.

A fourth example of the invention provides an apparatus, comprising:
at least one processor; and
at least one memory including computer program code
the at least one memory and the computer program code configured to, with the at least one processor, cause the apparatus to perform at least the following:
receive at the apparatus unsolicited graphical content for display;
adapt an existing graphical display so as to reduce the size of the display; and
combine the adapted existing display and the received unsolicited graphical content such that they do not substantially overlap. Within the fourth example the same further features may be employed, as described above in respect of the second example.

A fifth example of the invention provides a computer program or suite of computer programs so arranged such that when executed on a computing device it/they cause the computing device to operate in accordance with the first example or the second example. In an example, a machine readable storage medium storing the computer program or at least one of the suite of computer programs of the fifth example.

A sixth example of the invention provides a computer program, comprising:
code for receiving at an apparatus, over a logical data channel dedicated to the provision of unsolicited content, data packets containing unsolicited content for reproduction by the apparatus;
code for processing the received data packets in an operating system of the apparatus, to retrieve the unsolicited content therefrom; and
code for combining or replacing, using the operating system, content that is presently being reproduced by the apparatus with the unsolicited content.

A seventh example of the invention provides a computer readable medium having stored thereon a computer program according to the sixth example. Within the sixth and seventh examples the same further features may be employed, as described above in respect of the first example.

An eighth example provides a computer program, comprising:
code for receiving at the apparatus unsolicited graphical content for display;
code for adapting an existing graphical display so as to reduce the size of the display; and
code for combining the adapted existing display and the received unsolicited graphical content such that they do not substantially overlap.

A ninth example of the invention provides a computer readable medium having stored thereon a computer program according to the eighth example. Within the eighth and ninth examples the same further features may be employed, as described above in respect of the second example.

### BRIEF DESCRIPTION OF THE DRAWINGS

Features and advantages of some example embodiments of the present invention will become apparent from the following description, and by reference to the accompanying drawings, wherein:

FIG. 1 is a block diagram of a smartphone hardware architecture for use with some embodiments of the present invention;

FIG. 2 is a drawing illustrating the layers of software in the computing device of FIG. 1;

FIG. 3 is a block diagram illustrating a first embodiment of the present invention;

FIG. 4 is a diagram illustrating a packet structure used in a communications channel of the first embodiment of the invention;

FIG. 5 is a block diagram illustrating various components of the first embodiment of the present invention;

FIG. 6 is a flow diagram illustrating the functions performed in the first embodiment of the present invention; p FIG. 7 is a second flow diagram illustrating the functions performed in the first embodiment of the present invention;

FIG. 8 is a flow diagram illustrating the functions performed in a second embodiment of the present invention;

FIG. 9 is a pair of screen shots illustrating an aspect of the second embodiment of the present invention;

FIG. 10 is a pair of screen shots illustrating a further aspect of the second embodiment of the present invention;

FIG. 11 is a set of screen shots illustrating a further aspect of the second embodiment of the present invention; and

FIG. 12 is a set of screen shots and other views illustrating a further aspect of the second embodiment of the present invention.

### DESCRIPTION OF SOME EMBODIMENTS OF THE INVENTION

Some embodiments of the present invention are concerned with the receipt of unsolicited content, such as advertisement messages, but also including other data, such as network control data, warning messages, or the like, at an apparatus, and also how such unsolicited content is displayed to the user of the apparatus. For example, such unsolicited content can be combined with an existing display, or can replace the existing display. In one embodiment, a dedicated logical channel is provided for the communication of unsolicited content, and which terminates within the apparatus at a module provided for the task in the apparatus operating system. The channel links into the operating system of the apparatus, rather than a receiving application, as the OS is trusted, and can control other applications running on the apparatus to accommodate the received advert. For example, the operating system can change the display of other applications that are running on the apparatus, to provide display space for a received advert. The channel can also be used to provide feedback to the advertisement server, for example on the user's viewing pattern corresponding to the advertisement.

Another embodiment of the invention relates to how received unsolicited content is displayed on the display of the apparatus. In particular, the existing display is adapted by shrinking the display in one or both of the horizontal and/or vertical directions, so as to make room for the received content. The received content is then combined with the adapted existing display. In this way, both the received content and the existing display can be shown simultaneously, without one obscuring the other.

EP1 286 288 A1 describes a technique for distributing advertisements over a network. US2008/0147493 describes how advertisement information can replace one of the icons on a graphical user interface (GUI) of a device, and thereby become more visible to the user. In particular, an icon of the GUI is selected to be replaced, and the advert is displayed instead of the icon. The remainder of the GUI image remains unchanged.

A first embodiment of the present invention will now be described.

Many modern electronic apparatuses make use of operating systems. Modern operating systems can be found on anything composed of integrated circuits, like personal computers, Internet servers, cell phones, music players, routers, switches, wireless access points, network storage, game consoles, digital cameras, DVD players, sewing machines, and telescopes. An operating system may be the software that manages the sharing of the resources of the apparatus, and provides programmers with an interface to access those resources. An operating system may process system data and user input, and may respond by allocating and managing tasks and internal system resources as a service to users and programs on the system. At its most basic, the operating system may perform tasks such as controlling and allocating memory, prioritising system requests, controlling input and output devices, facilitating networking, and managing files. An operating system may be in essence an interface by which higher level applications can access the hardware of the apparatus.

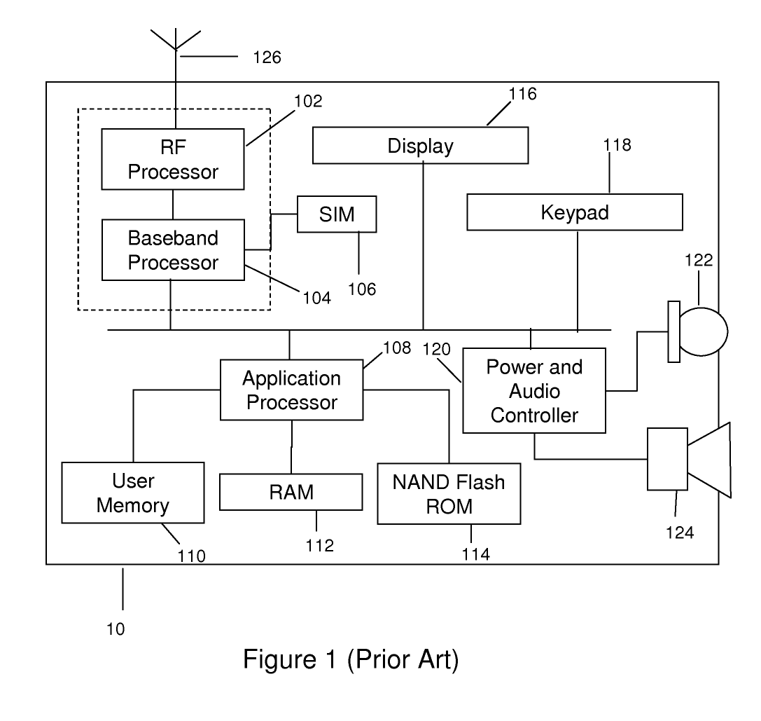

Many modern electronic apparatuses which make use of operating systems have as their basis a similar physical hardware architecture, making use of an application processor provided with suitable memory which stores the apparatus operating system, as well as the higher level application programs which determine the functionality of the apparatus. The operating system and other programs are typically stored in non-volatile Read-Only Memory, and the operating system is usually loaded first, to allow the application process to then run the higher level application programs. One very common modern electronic apparatus which makes use of an operating system is a smartphone, the generic hardware architecture for which is shown in FIG. 1.

With reference to FIG. 1, a smartphone 10 comprises hardware to perform the telephony functions, together with an application processor and corresponding support hardware to enable the phone to have other functions which are desired by a smartphone, such as messaging, calendar, word processing functions and the like. In FIG. 1 the telephony hardware is represented by the RF processor 102 which provides an RF signal to antenna 126 for the transmission of telephony signals, and the receipt therefrom. Additionally provided is baseband processor 104, which provides signals to and receives signals from the RF Processor 102. The baseband processor 104 also interacts with a subscriber identity module 106, as is well known in the art. The telephony subsystem of the smartphone 10 is beyond the scope of the present invention.

Also typically provided is a display 116, and a keypad 118. These are controlled by an application processor 108, which can be a separate integrated circuit from the baseband processor 104 and RF processor 102, although in the future it is anticipated that single chip solutions will become available. A power and audio controller 120 is provided to supply power from a battery (not shown) to the telephony subsystem, the application processor, and the other hardware. Additionally, the power and audio controller 120 also controls input from a microphone 122, and audio output via a speaker 124.

In order for the application processor 108 to operate, various different types of memory are provided. Firstly, the application processor 108 is provided with some Random Access Memory (RAM) 112 into which data and program code can be written and read from at will. Code placed anywhere in RAM can be executed by the application processor 108 from the RAM.

Additionally provided is separate user memory 110, which can be used to store user data, such as user application programs (typically higher layer application programs which determine the functionality of the device), as well as user data files, and the like.

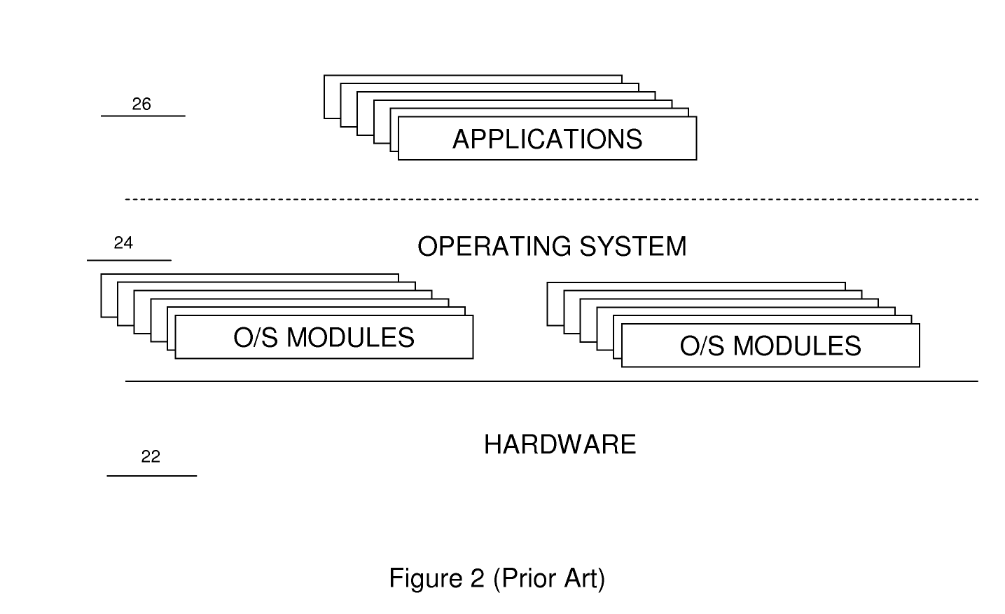

As mentioned previously, in order for the application processor 108 to operate, an operating system is necessary, which is usually started as soon as the smartphone system 10 is first switched on. In the present embodiment, the operating system code is stored in a Read-Only Memory comprised of NAND Flash ROM 114. In some other embodiments, the operating system could be stored elsewhere on the device, and the read-only memory could be of a different type. The ROM can store the necessary operating system component in order for the device 10 to operate, but other software programs may also be stored, such as application programs, and the like, and in particular those application programs which are mandatory to the device, such as, in the case of a smartphone, communications applications and the like. These could be the applications which are bundled with the smartphone by the device manufacturer when the phone is first sold. Further applications which are added to the smartphone by the user would usually be stored in the user memory 110. Thus, as shown in FIG. 2, conceptually the smartphone 10 can be considered as having layers of hardware, and software, being the physical hardware 22, the operating system 24, which itself comprises many different software modules and components, and applications 26, being further software modules and components. The operating system layer is particularly important, as it has control of the device hardware, and can control the access and usage of such hardware by other applications running on the device.

Within the first embodiment of the present invention a dedicated logical channel is provided over which unsolicited content can be provided via a network to a computing device. The dedicated channel provides unsolicited content from an unsolicited content server, via the network, to an unsolicited content module provided in the operating system of the computing device. The reason why the channel terminates in the operating system, rather than in an application layer application, is that the operating system has greater control over the device, and in particular can dictate to other applications running on the device how they are to operate. Thus, for example, a module in the operating system can cause the display of other applications to be displayed differently, for example to make way for the display of unsolicited content on the computing device display. The computing device in the first embodiment is a smartphone or the like, although it should be understood that this is not essential to the present invention, and any other computing device provided with a display may also be used, such as, for example, a desktop computer, a laptop computer, a PDA, etc. etc.

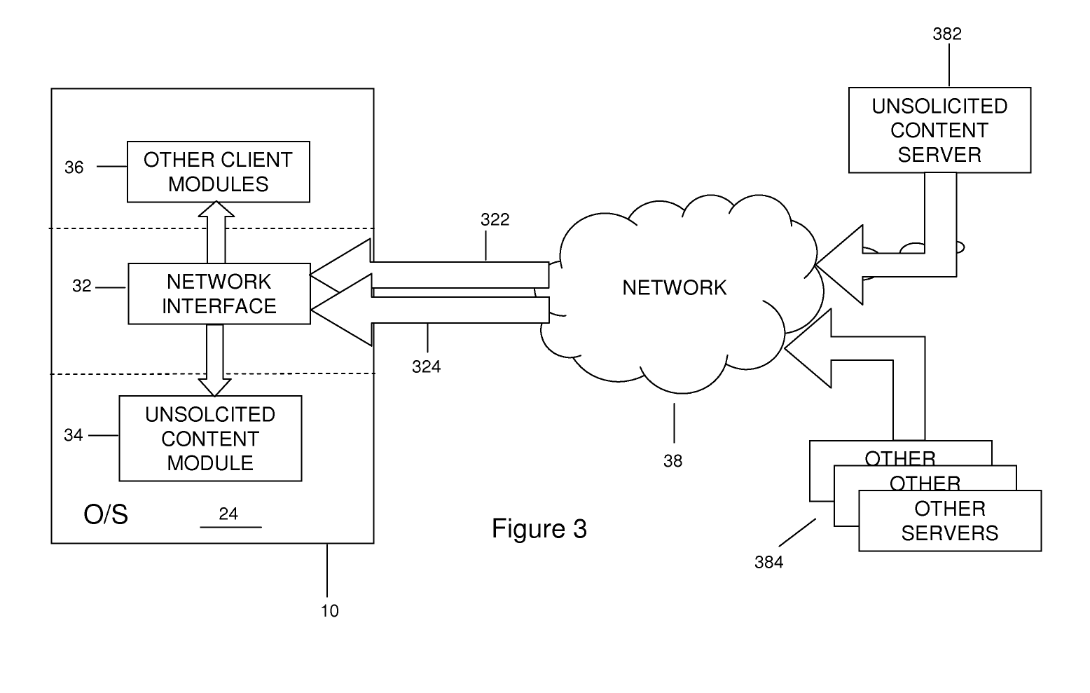

FIG. 3 is a block diagram illustrating components of the first embodiment, to be described. More particularly, the computing device 10 is provided with a network interface 32, which is arranged to receive data over logical channels 322, 324, etc., via network 38. Data is sent over the logical channels 322, 324, etc. by servers elsewhere in the network. For present purposes, of most importance is that there is an “unsolicited content server” 382, which provides unsolicited content via the network 38 and the logical channels 322, 324 to the network interface 32 of the computing device 10. Of course, within such a network, which may, for example, be the Internet, provided with a gateway to a cellular network to access a mobile computing device, other servers 384 will also be present, and which can provide other content (typically solicited) to the computing device 10.

It should be noted that data sent from the unsolicited content server 382 has a particular packet format, to be described later, but which allows the computing device 10 to determine that unsolicited content from the unsolicited content server 382 is being received. The data packets may be sent over a dedicated logical channel 322, or may be interleaved with other packets being sent over the logical channels 322 and 324, and received at the network interface 32. Additionally, a dedicated physical channel may be set aside for the unsolicited content. Within the computing device 10 there are provided other client application modules 36, which receive content from the other servers 384 over network 38. For example, these may be, for example, browser programs, media player programs, or the like, as is known in the art. Such other client modules 36 are typically located in the application layer of the computing device 10. Packets meant for these other client modules are routed to them via the network interface 32, as shown.

According to the present embodiment, however, the unsolicited content module 34 is provided in the operating system, being an appropriate component to receive and interpret unsolicited content packets received at the network interface 32 from the unsolicited content server 382. Therefore, the network interface 32 identifies the unsolicited content packets, and directs them to the unsolicited content module 34, wherein their contents are interpreted and acted upon, in a manner to be described. The unsolicited content module 34 is located within the operating system 24 of the computer device 10, for the reason, as mentioned, that modules within the operating system have greater access to the hardware of the device, and can override use of that hardware by other applications, and even other modules within the operating system. This is important in the present context, to allow the unsolicited content module 34 to be able to act upon the received unsolicited content in the correct manner, such as by displaying received content, in the case of graphical content on the display of the computing device 10. As another example, in the case of audio content, because the unsolicited content module 34 is in the operating system, then it can override any application that may be using an audio output of the computing device 10, so as to play received audio content thereover.

Additionally, because the unsolicited content module 34 is in the operating system, then it will be a trusted component in that its operation should be reliable. Hence, the unsolicited content module can monitor user operations on the computing device in response to receipt of unsolicited content, and can provide information regarding user operations in response to unsolicited content back to the unsolicited content server 382. In this way, for example, when the unsolicited content is an advertisement, then feedback as to the user's reaction to the advertisement can be provided to the unsolicited content server in a secure and trusted manner.

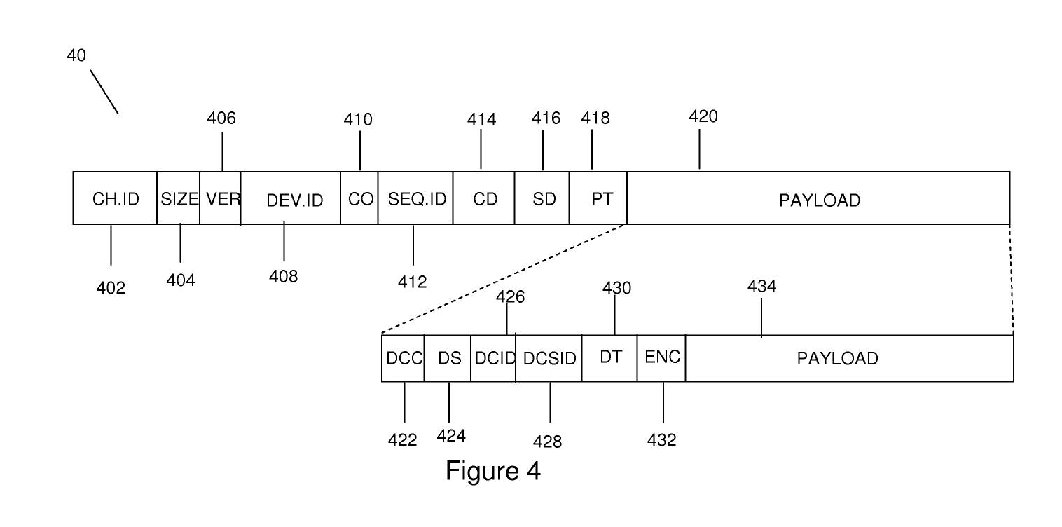

FIG. 4 illustrates the format of packets sent over the dedicated unsolicited content channel from the unsolicited content server 382 to the unsolicited content module 34 in the OS. More particularly, packet 40 comprises a number of fields, discussed below.

Firstly, packet 40 comprises a channel hex ID field 402. This is a channel stream identifier in hexadecimal. This value should have a unique value embedded to distinguish the unsolicited content stream if it is interleaved with the communication/data stream. This field acts to identify the packet as belonging to the stream of unsolicited content packets.

The next field is the packet size field 404. This identifies the total size of the unsolicited content packet. Field 406 then follows, and this is the channel client/server version field, which identifies the version of the unsolicited content server software when receiving the stream. When sending feedback, this field identifies the version of the client i.e. the unsolicited content module 34 in the computing device 10.

Next is field 408, which is a device or server ID field. This field identifies the client device when sending feedback to the unsolicited content server. When receiving a stream of packets from the unsolicited content server, then this value identifies the server.

Field 410 contains a value as to whether the packet is part of an earlier packet, and if there is another packet to follow that is part of this packet. In particular, the field contains a “continue from last packet” indicator, and a “packet to follow” indicator. If the “continue from last packet” indicator is zero then this is the first packet of the sequence. If the “packet to follow” indicator is zero, then this is the last packet in the sequence.

Because multiple packets can be used in sequence, field 412 contains a sequence ID, that is the sequence identifier. All packets pertaining to the same sequence have the same ID in this field.

Fields 414 and 416 relate respectively to the packet creation date and time, and the packet sent date and time, being the respective dates and times when the packet was created on the server or client, and the date in time when the packet was sent from the server or client.

Field 418 indicates the payload type. Because the unsolicited content channel can encapsulate other protocols, such as SIP, then it is necessary to identify the type of the payload that is being carried in the packet. The payload itself is carried in field 420, and, as mentioned, may in fact be an encapsulated data packet of another protocol. If this is the case, then the data within the payload, including any headers belonging to the encapsulating protocol of the data therein, should be passed to the appropriate protocol handler. Alternatively, if the payload type field 418 indicates that the type is “self”, then this means that the unsolicited content module itself should handle the packet data. If the payload type is “self”, then the payload field 420 will contain a further sub-packet as shown, and containing the following fields.

More particularly, the sub-packet, when the payload is of type “self”, contains first field 422, which is a data chunk count field, that identifies how many data chunks there are in the packet. The data size field 424 identifies the size of the data chunk, and the data chunk ID field 426 identifies the chunk itself. This will be the same for all the chunks that are related across or within the packet. The data chunk ID field is used to gather all the related chunks together.

The data chunk sequence ID field 428 identifies the sequence of the chunk. This is used to compose a bigger data chunk from all the gathered related chunks. The data type field identifies what is the type of the data chunk itself. For example, it could be audio, video, graphics, plain text, etc. The encoding field 432 identifies the encoding of the binary data, and then at 434 we have the actual data itself, in binary. Where the binary data contains graphics data i.e. the data type field 430 indicates that the binary data is graphics data, encoded according to that indicated in the encoding field 432, then as well as the graphics data, control information can also be provided, such as whether the graphics should be overlaid or accommodated on the display, as well as the start_X, start_Y, end_X, and end_Y position on the display. Thus, where graphical data is received as unsolicited content, then control data accompanies the graphical data, so as to indicate how and where the graphical data should be displayed on the screen. Further details in respect of this aspect of the present invention will be described later.

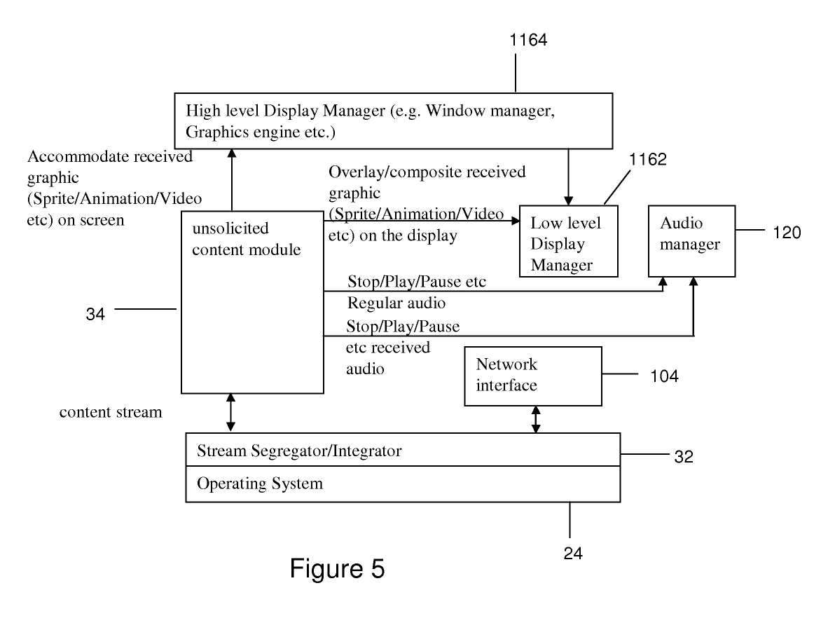

Having described the unsolicited content channel packet structure, FIG. 5 gives a brief overview of how the unsolicited content module 34 interacts with the hardware of the device. More particularly, as shown in FIG. 5, data that is received at the network interface 104 is passed, via a stream segregator/integrator layer 32, if the packets are to be interlaced with other packets, through the operating system 24 to the unsolicited content module 34. The unsolicited content module 34 then processes the data in accordance with the packet structure in a manner to be described, and then controls the hardware of the device so as to display or play the content. For example, where the content includes audio data, then the audio controller 120 can be controlled so as to stop, play, pause, etc. the regular audio, and to cause the received audio content to be played. Similarly, the unsolicited content module 34 also interacts with the low level and high level display managers 1162 and 1164 in the OS, so as to cause the unsolicited received graphic information, such as a sprites, animation, video, or the like to be displayed on the screen. In particular, it interfaces with the low level display manager 1162 so as to instruct the display manager as to how the received graphic is to be rendered onto the display, and interfaces with the high level display manager 1164 e.g. a graphics engine, Windows manager, or the like at the same time, in order for the present display to be adapted, if required, in order to accommodate the received graphic data.

Further details of these operations will become apparent based on the following description.

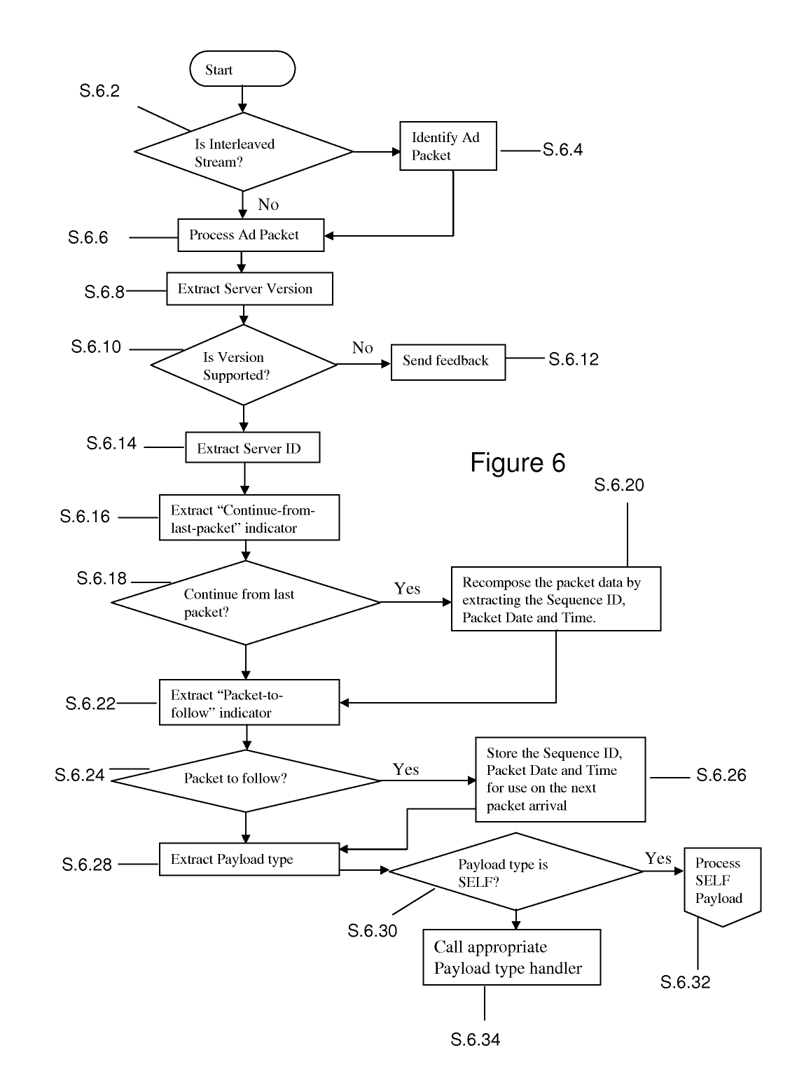

FIG. 6 and FIG. 7 together show the processing that is performed to packets received on the unsolicited content channel, and that have a packet format according to FIG. 4, described previously. Firstly, at block 6.2 a determination is made as to whether the packet has been received on an interleaved stream with packets of other types. If this is the case, then at block 6.4 the unsolicited content packet is identified using the hexadecimal unsolicited content channel ID field 402. If the packet is not being received on an interleaved stream, and is being received on a dedicated channel, then this block is not necessary, and processing proceeds to block 6.6, wherein a received packet is processed.

Firstly, therefore, to process a received packet, at block 6.8 the server version is extracted from the server version field 406. An evaluation is then performed at block 6.10 as to whether the unsolicited content module 34 supports the version indicated, and if not, a feedback message is sent at block 6.12, and processing there ends. Assuming that the version is supported, next, at block 6.14, the server ID is extracted from the device ID field 408. Next, at block 6.16, the continue-from-last-packet indicator value is extracted from field 410. If this indicator indicates that the process should continue from the last packet, as determined by the evaluation at block 6.18, then at block 6.20, the packet data is recomposed by extracting the sequence ID, packet data, and time. Processing then proceeds to block 6.22.

Here, the packet-to-follow indicator is extracted from field 410. If this indicates that there is a packet to follow (as determined by the packet to follow evaluation at block 6.24), then at block 6.26 the sequence ID is stored, together with the packet date and time, for use on the next packet arrival. Processing then proceeds to block 6.28, wherein the payload type data is extracted from the payload type field 418.

The payload type is then examined, and if the payload type is of type “self”, then processing proceeds to block 6.32, described further with respect to FIG. 7, below. Alternatively, if the payload type is another type (and recalling that the unsolicited content packet can encapsulate data of other protocols), then the appropriate payload type handler is called at block 6.34, and the payload is passed thereto for processing. For example, where the payload type is a SIP packet, then a SIP handler in the computing device 10 is called, and the payload is passed to the SIP handler.

FIG. 7 illustrates the processing of the sub-packet, when the payload type field 418 indicates that the payload is of type “self”. In particular, the fields of the sub-packet are concerned with allowing data to be extracted from the payload, and combined with data from other sub-packets from other unsolicited content packets, so as to build up a larger chunk of data. Therefore, content can be split between different unsolicited content packets, and then reconstructed at the receiving client.

The sub-packet is processed as follows.

Firstly, at block 7.4 the chunk count is extracted from the data chunk count field 422. If the count is equal to zero, as determined by the evaluation performed at block 7.8, then the next packet is processed at block 7.6. This is because the data chunk count value identifies how many data chunks there are in the packet, and if the count is of zero, then there are no data chunks in the packet.

If the count is larger than zero, then at block 7.10 the count is decremented, and then at block 7.12 the data chunk is extracted, followed by the chunk IDs, at block 7.14, from field 426. The chunk ID is then examined at block 7.16, and if the chunk ID has already been processed, then processing proceeds to block 7.18, wherein the chunk sequence ID is extracted from field 428. According to the sequence ID, the chunk data can be recomposed at block 7.20, to allow a bigger data chunk to be composed from other chunks that have been previously received in other sub-packets.

Next, at block 7.22, the chunk data type is extracted from field 430, and the encoding type extracted at block 432. The chunk data is then extracted from the payload field 434 at block 7.26 together with any control data, which is dependent upon the data type, at block 7.28. At this point, therefore, the unsolicited content module has parsed the received unsolicited content packet, as well as the sub-packet, has recomposed data that has been spread over several packets, and has determined the data type, and the encoding. Therefore, at block 7.30, the recomposed data can be passed to the appropriate data decoder depending on the encoding applied. For example, if the received data is graphics data that has been JPEG encoded, then a JPEG decoder can be used to decode the data. Depending on the data type of the received data, therefore, at block 7.32 and block 7.34 the received and decoded data is passed to the appropriate module in the computing device, so as to be displayed or played to the user. For example, where the received data is audio data, then the unsolicited content module can control the audio manager so as to play the received data.

Alternatively, where the received data is of a graphics type, such as a sprite, animation, or video, then the unsolicited content module can control the display managers so as to cause the graphics data to be displayed on the computing device display. How received graphics data is displayed will be described later with respect to a second embodiment of the invention.

With the first embodiment of the invention, therefore, a dedicated logical channel is provided for unsolicited content, to allow unsolicited content to be passed from an unsolicited content server in a network to a computing device, and in particular to a module located within the operating system of the device. That module can then extract the unsolicited content, decode the content, and then control appropriate hardware of the device so as to cause the content to be provided to the user via the outputs of the device, such as a display, or an audio output. For example, the content can be combined with an existing display being displayed on a screen or can replace the existing display. Receipt of unsolicited content via a dedicated channel that terminates in the device operating system has several advantages. In particular, the operating system can ensure that the content is reproduced, if necessary in place of content that is presently being reproduced. Stated differently, the operating system can ensure that the content is combined with, or replaces content that is presently being reproduced. This ensures that the user gets to see the content.

The first embodiment of the invention has several advantages. Firstly, it ensures that only those unsolicited content providers which the network that provides access to the device is prepared to support can access the unsolicited content channel, to provide content to the device. This is particularly important for mobile devices. In this way, the unsolicited content channel provides a single route to the device over which unsolicited content can be provided. The network can therefore gain extra revenue by renting out access to the unsolicited content channel to advertisers so as, for example, to allow advertisers to send adverts over the solicited content channel to the device.

Alternatively, the unsolicited content channel can also be used for other purposes, for example to send information messages, or warning messages to the user. Because the unsolicited content channel terminates at a module in the operating system, which can then access the device hardware and override other applications to ensure that the content is displayed to the user, then the provision of the unsolicited content channel provides advantages in terms of guaranteeing (as far as possible), that the user will see the content.

In short, provision of a dedicated logical data channel for the unsolicited content provides a single route into the device for such content, over which greater control can be obtained, both by the user of the device, and also by the operator of a server at the other end of the channel. For example, where the device is a mobile device, then the mobile network operator may wish to lease out capacity on the channel to advertisers. They may also wish to use the channel themselves for important service messages, or warning messages.

A second embodiment will now be described relating to how unsolicited content can be combined with an existing display and displayed on a display of a computing device. The second embodiment in the invention can be considered as a stand alone embodiment, that can be used to combine and display unsolicited content howsoever the content is received. Alternatively, the second embodiment of the invention can be combined with the first embodiment of the invention which provides a dedicated unsolicited content channel directly into the OS. The description below concentrates on this second aspect i.e. where the second embodiment is used as an add-on to the first embodiment, and hence description is given in respect of the same elements of the first embodiment as previously described. It should, however, be understood that the second embodiment can be used as a stand alone embodiment, and that the same processing blocks will be performed irrespective of how the unsolicited content is actually received at the device.

Before describing the operation of the second embodiment in detail, a brief overview of its operation will be given, with respect to the drawings.

The streamed unsolicited content data, apart from other information, may contain details on how to display the content, as discussed above in respect of the first embodiment. This is applicable when the content contains graphics information. The content can be without graphics and may support non-graphics data. However, when graphics data is supplied (such as an image, animation, or video), then the data may also be accompanied by size data (in the form of start and end X and Y coordinates), position data (such as how to orient the graphic on the screen), and display type data (such as whether to overlay the graphic, or adapt other screen elements to accommodate it).

For the unsolicited content module in the OS to display adverts on screen, two pieces of information along with other graphics data is expected by the module within the OS. These two things are, the position and size of the advert and the way it has to be displayed i.e. as translucent overlay or to squeeze the screen.

The unsolicited content stream format described in the first embodiment specifies the payload data for type “SELF”. This payload data contains a payload field which contains the data identified by Data Type and Encoding fields. If the Data Type is Graphics then the size, position and display mechanism (i.e. overlay or squeeze) extracted from the graphics data is used to display the content at the specified position within the specified size on the screen using the specified display mechanism. If the size, position and display mechanism is not available within the graphics data, then the module can use the default values. The default size of the graphics content is the screen width and 15% of the screen height. The default position is the bottom of the screen and the display mechanism is translucent overlay. In some embodiments, these default values are configurable by the user.

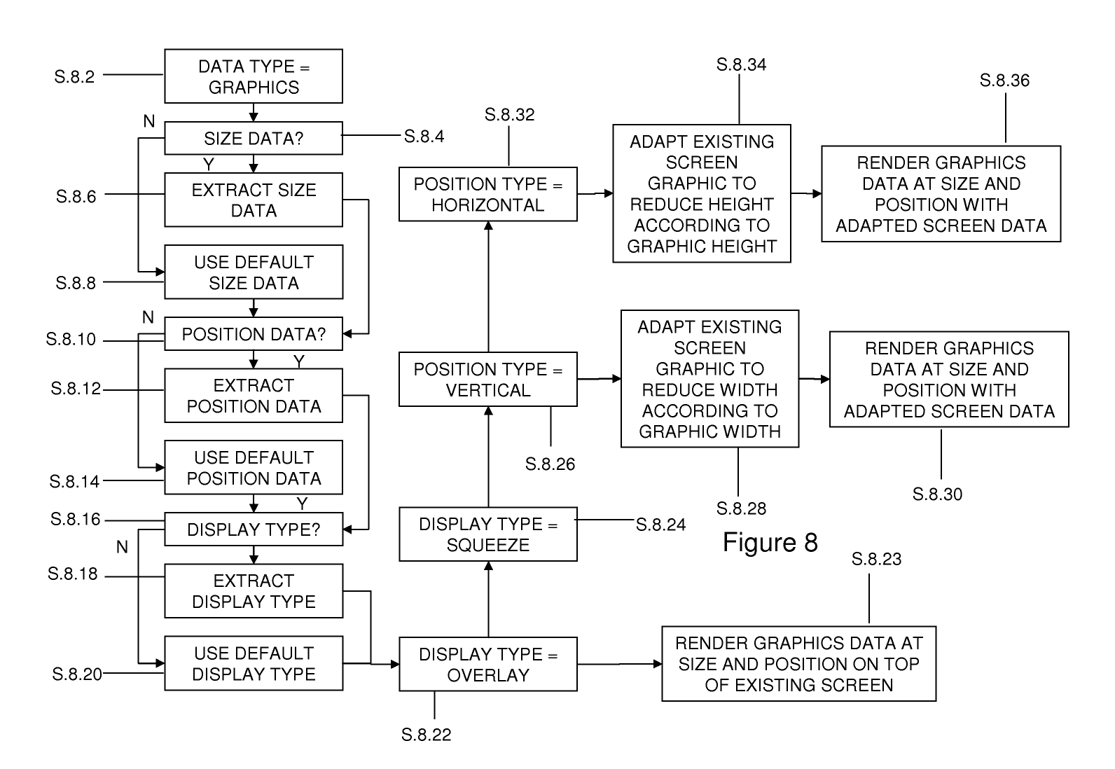

FIGS. 9 to 12 show a few of the graphics content placements that can be achieved by the unsolicited content module with the help of the graphics subsystem of the OS. They can be any combination of the shown diagrams, e.g. the horizontal and vertical graphics can be placed simultaneously on the same display or vertical and horizontal graphics can be displayed at different positions i.e. at the right and at the top respectively, or both the overlay and squeeze mechanism can be used simultaneously e.g. vertical adverts squeeze the display whereas horizontal adverts overlay on top of the screen in the same frame. In short there is no enforcement from the OS as to where and how the graphics content can be shown (they can even be shown at the centre of the screen). The OS also does not control how many individual graphics items can be shown simultaneously. This information is received from the remote unsolicited content server.

As described in the first embodiment, the unsolicited content module makes use of the OS graphics subsystem to display the received graphics content. The unsolicited content module apart from providing the graphics data, sends the size, position and display mechanism for the content to the graphics subsystem. The graphics subsystem then uses this information to display the advert. The decoding of the graphics data such as GIF, JPEG, WMF, MPEG etc is known in the art.

Once the unsolicited content module extracts the size, position, display mechanism and graphics decoder information, control passes to the graphics subsystem. The graphics subsystem of the OS uses the appropriate decoder to extract the graphics data. This data is then displayed on the screen with the specified size and position using the specified mechanism.

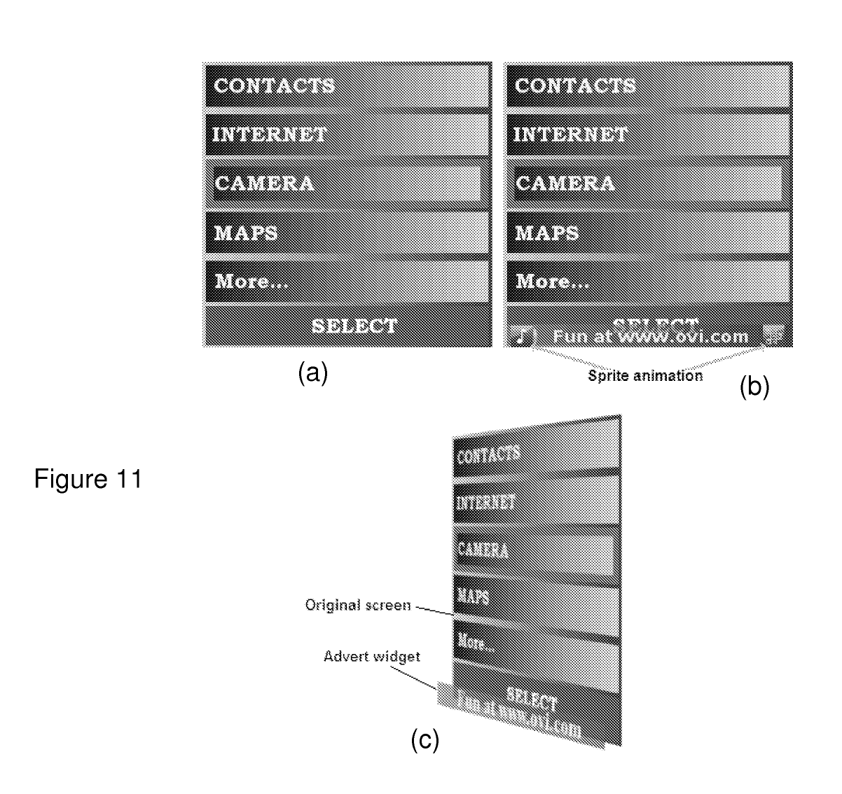

There are two display mechanisms proposed by the second embodiment, the “overlay” and the “screen squeeze”. The overlay mechanism is shown in FIG. 11(a) and (b). Overlaying received graphics data on the current displayed frame is the simpler of the two mechanisms. A graphics UI widget that is capable of displaying all the supported graphics data is composed on top of the screen. The unsolicited content module is responsible for creating the graphics UI widget. This UI widget has a special property within the graphics subsystem. It can be rendered in front of all the other UI elements on the screen. This is shown in FIG. 11(c), which is a side view of FIG. 11(b).

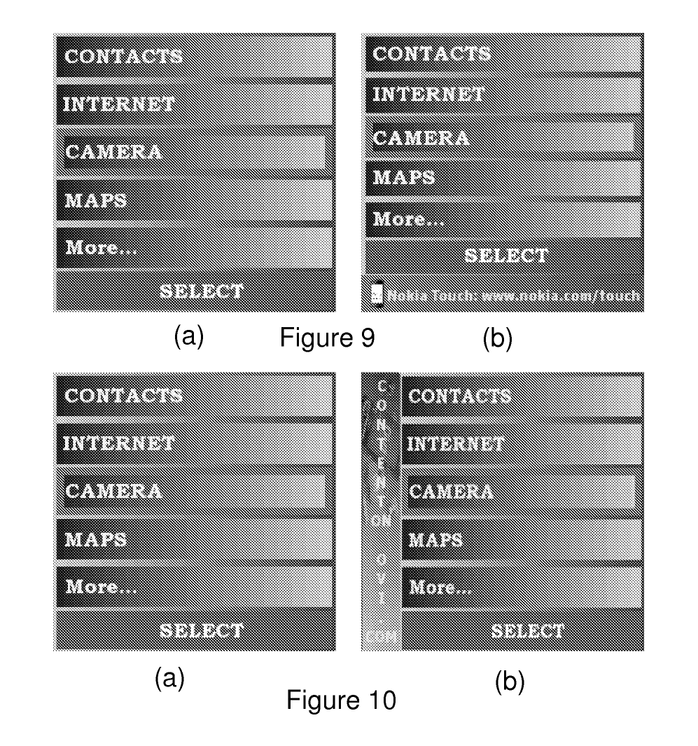

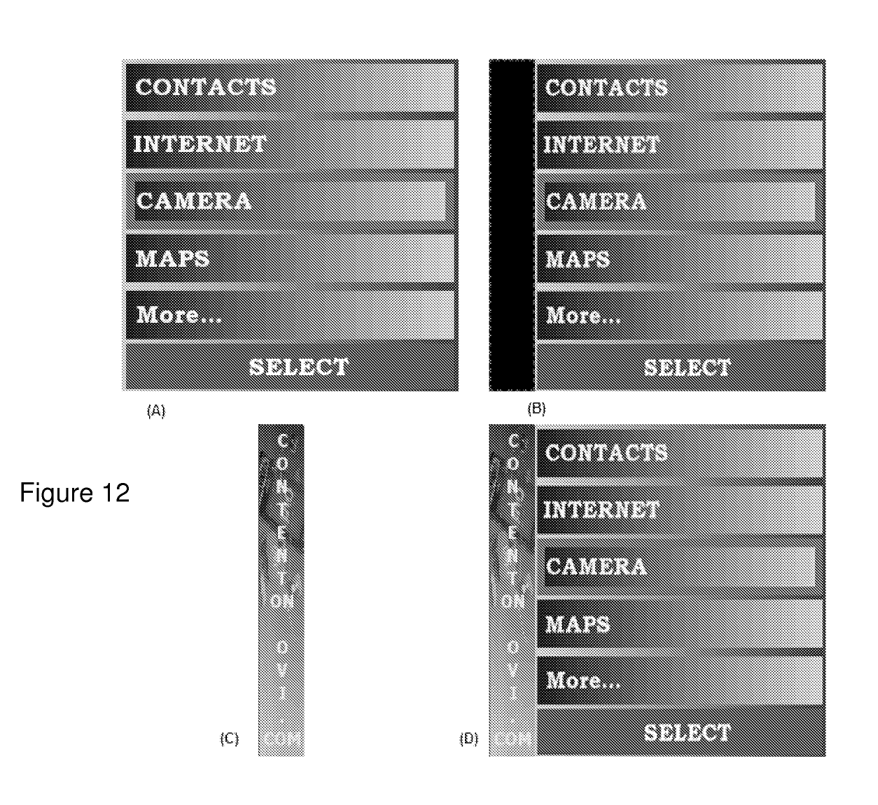

The screen squeeze mechanism acts to squeeze the original screen to accommodate the received graphics content. This is shown in FIGS. 9 and 10. There are two approaches taken to resize the screen to display the graphics content. The first approach is to send a resize event to all the graphics UI elements in the scene. It is the responsibility of the UI elements to take into account the new size of the screen and resize accordingly. Another approach supported is related to resizing the final screen image instead of resizing each UI element. The received graphics content is then copied into the display area not covered by the screen image. The interpolation algorithm used during resize, such as Sinc, Cubic, Linear etc should be configured during the OS build. FIG. 12 shows an example of resizing the final screen image.

In FIG. 12, image (A) shows the final screen image constructed before received graphics content is displayed. This screen image is resized depending upon the size and position of the content. In the above example, as shown in image (B), the content is placed at the left side of the screen. Image (C) shows the actual graphics content image constructed from the graphics data received from the unsolicited content module. This image is copied to the area of the display not covered by the screen, in this case the left side of the display as shown in image (D). Which approach to resize the screen is supported in the OS is preferably configured at the OS build time.

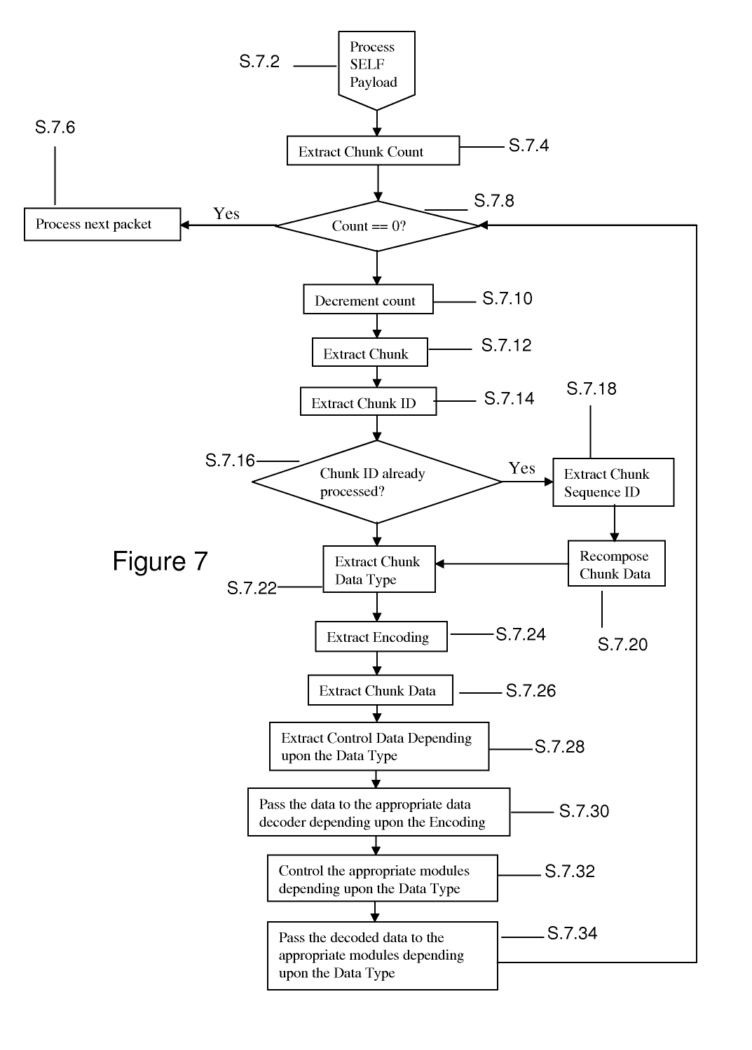

Having given a brief overview of the operation of the second embodiment, FIG. 8 illustrates the operation in more detail. Note that in the present embodiment the processing required is performed by the unsolicited content module in combination with the graphics subsystem of the operating system, and this is irrespective of how the received unsolicited graphics content is provided to the device. For example, it may be provided over the dedicated unsolicited content channel described with respect to the first embodiment, or it may be provided in some other way, for example using conventional means such as SMS, email, or MMS messages.

Howsoever the content is provided to the device, at block 8.2 once the unsolicited content module has determined that the data type is of a graphics data type that is to be displayed on the screen it then first, at blocks 8.4 to 8.20, determines various properties of the graphics, and in particular, the size of the graphics, the position at which it is to be displayed on the screen, and the display type.

More particularly, at block 8.4 the unsolicited content module determines whether the graphics data was accompanied by size data, specifying a start X, end X, start Y, and end Y size of the data, in terms of numbers of pixels in the horizontal and vertical direction that the image is to take up. If there is size data accompanying the graphics data, then at block 8.6 this is extracted. If no size data accompanies the graphics data, then a default size is used, as discussed above. This is typically 15% of the screen height.

Next, position data on the screen is extracted, and in particular whether the graphic should be aligned horizontally, or vertically. Again, position data may accompany the graphics data, and this is determined by the evaluation performed at block 8.10. If there is position data, then it is extracted at block 8.12, but if not, then a default position data is used. The default position is, as mentioned, horizontally, at the bottom of the screen.

Next, the display type is extracted, if available. The evaluation at block 8.16 determines whether there is display type data accompanying the graphics data, and if so it is extracted at block 8.18, and if not, the default display type is selected at block 8.20. The default display type is translucent overlay, as mentioned. As noted previously, there are essentially two display types, being overlay, and squeeze.

After the above blocks, therefore, then the graphics themselves have been extracted from any received data, as well as graphics meta-data, such as the size, position, and display type of the graphics. The unsolicited content module then passes this information to the graphics subsystem of the operating system, which then acts to implement the display of the graphics on the screen, in accordance with the received and extracted graphics meta data, or the default values.

Firstly, the graphics subsystem determines whether the display type is of type “overlay”, at block 8.22. As noted previously, this is the easiest display type to implement, because it simply means that the received graphics can be rendered on top of the existing screen graphics as described previously with respect to FIG. 11. If the display type is of display type “overlay”, then at block 8.23 the graphic subsystem VOS renders the graphics data on top of the existing screen data, at the size and position noted by the graphics meta-data, or in accordance with the default. This results, as shown in FIG. 11, with received unsolicited graphics, in this case being advert graphics, being overlaid on top of the existing screen display. In this case, the existing screen display is a user interface, showing graphical buttons.

If the display type is not of type “overlay”, then it is of type “squeeze” as determined at block 8.24. For type “squeeze”, there are two main subsets, dependent on the position data. These are that the existing screen graphics can be squeezed horizontally, or vertically (or both), depending on where the received unsolicited graphics content is to be placed. At block 8.26 an evaluation is made as to whether the position data indicated that the received unsolicited graphics data was to be placed vertically. If this is the case, then the graphic subsystem adapts the existing screen graphics to reduce the width thereof, according to the received unsolicited graphics width, at block 8.28. This operation was shown and described previously with respect to FIG. 12. Then, having obtained the reduced-width existing screen graphics, both the received unsolicited graphics with the vertical orientation, and the adapted existing screen graphic can be displayed at the same time, as shown in FIG. 12(d).

Alternatively, instead of squeezing the screen horizontally, it may instead be squeezed vertically. This will be the case where the position data is of type “horizontal”, as determined at block 8.32. In this case, the existing screen graphic is then adapted to reduce its height, according to the height of the received unsolicited graphic, and this is performed by the graphic subsystem at block 8.34. Then, the graphic subsystem renders the screen using the adapted existing screen graphic of reduced height, and the received unsolicited graphics content at block 8.36. An example is shown in FIGS. 9a and b. Here, it will be seen that the existing graphics content shown in FIG. 9a has had its height reduced so as to accommodate the received unsolicited graphics content (in this case again an advert) as shown in FIG. 9b.

It should be noted, that whilst we have described in the present embodiment the position as being either horizontally or vertically oriented at the edge of the display screen, the invention is not limited to this, and the received unsolicited graphic can be placed in the centre of the screen. For example, where it is to be placed horizontally in the centre of the screen, then the existing graphics content is divided into two, and each part then has its height reduced accordingly (each by half the amount that would otherwise be the case if it remained as a single image), and then the two reduced height portions of the existing screen can be placed around the received unsolicited graphic. A similar operation can be performed if the received unsolicited graphic is to be placed vertically.

With the second embodiment, therefore, an existing display can be adapted to accommodate received unsolicited graphics content, so that the received unsolicited graphics content can be displayed without overly interfering with the original content. In some embodiments, the original content is squeezed to provide room on the display for the unsolicited received graphics content. By “squeeze” we mean that the original display contents are reduced in size, to provide room on the display for the unsolicited received graphics content to be displayed.

In the second embodiment, the existing graphical display is adapted in dependence on the size of the received unsolicited graphical content, or on the intended position of the received unsolicited graphical content. Additionally or alternatively, the existing graphical display is adapted in dependence on the intended orientation of the received unsolicited graphical content. It is an advantage of the second embodiment that by taking into account of the properties of the unsolicited content when adapting the existing display, then the existing content and the unsolicited content can be combined together. Furthermore, the combination can provide an optimal display of both the existing content and the unsolicited content. It is another advantage of the second embodiment that in order to achieve such optimisation, and to provide additional control over the display of the content by the sender of the unsolicited content, the unsolicited graphical content is accompanied by meta-data relating to the intended display properties of the unsolicited graphical content. These display properties are then taken into account when the existing graphical display is adapted and combined with the unsolicited content.

It is a further advantage of the second embodiment that the combining function is further arranged to combine the adapted existing display and the received unsolicited graphical content such that they are contiguous because this makes use of the most amount of available screen area when the combination is displayed.

When the first embodiment is combined with the second embodiment and the unsolicited content is visual content, the combined embodiment is advantageous because presently displayed visual content is adapted to accommodate the unsolicited visual content such that the present visual content and the unsolicited visual content are combined together. Furthermore, the combination of the present visual content and the unsolicited visual content can be displayed simultaneously. This means that the unsolicited content is not as intrusive to the user as would be the case where the present content is completely replaced by the unsolicited content. Further, where the presently displayed content is reduced in size in one dimension, whilst retaining its original size in an orthogonal dimension, this provides for relatively straightforward graphical processing when the presently displayed content and the unsolicited content are combined and then displayed. Accordingly to this operation, processing overhead is not increased unnecessarily. In mobile devices that are typically resource constrained such that processing overhead equates to power consumption and hence battery life, this is important.

It will be appreciated that various modifications, additions, and deletions may be made to the above described embodiments, to provide further embodiments, any and all of which are intended to be encompassed by the appended claims.

1-19. (canceled)

20. A method, comprising:
processing at an apparatus data packets containing unsolicited content;
causing at least in part processing of the data packets to retrieve the unsolicited content there from; and
determining to combine or replace or modify, a content that is presently being reproduced by the apparatus with the unsolicited content.

21. A method according to claim 20, wherein the unsolicited content is audio content and/or visual content.

22. A method according to claim 21, wherein in the case of visual content, presently reproduced visual content is adapted to accommodate the unsolicited visual content such that the present visual content and the unsolicited visual content are combined to be displayable simultaneously.

23. A method according to claim 22, wherein the adaptation comprises reducing the size of the presently reproduced visual content so as to make room for the unsolicited visual content when combined therewith.

24. A method according to claim 23, wherein the presently reproduced content is reduced in size in one dimension, whilst retaining its original size in an orthogonal dimension.

25. A method according to claim 22, wherein combining the present visual content and the unsolicited visual content such that they overlay.

26. A method according to claim 22, wherein combining the present visual content and the unsolicited visual content such they do not substantially overlap.

27. A method according to claim 20, wherein the unsolicited content is accompanied by meta-data relating to the intended rendering properties of the unsolicited content.

28. A method according to claim 20, wherein receiving the data packets containing unsolicited content over a logical data channel dedicated to the provision of unsolicited content.

29. An apparatus, comprising:
at least one processor; and
at least one memory including computer program code for one or more programs,
the at least one memory and the computer program code configured to, with the at least one processor, cause the apparatus to perform at least the following:
process at the apparatus data packets containing unsolicited content;
cause at least in part process of the data packets to retrieve the unsolicited content there from; and
determine to combine or replace or modify a content that is presently being reproduced by the apparatus with the unsolicited content.

30. An apparatus according to claim 29, wherein the unsolicited content is audio content and/or visual content.

31. An apparatus according to claim 30, wherein in the case of visual content, presently reproduced visual content is adapted to accommodate the unsolicited visual content such that the present visual content and the unsolicited visual content are combined to be displayable simultaneously.

32. An apparatus according to claim 31, wherein the adaptation comprises reducing the size of the presently reproduced visual content so as to make room for the unsolicited visual content when combined therewith.

33. An apparatus according to claim 32, wherein the presently reproduced content is reduced in size in one dimension, whilst retaining its original size in an orthogonal dimension.

34. An apparatus according to claim 31, wherein combining the present visual content and the unsolicited visual content such that they overlay.

35. An apparatus according to claim 31, wherein combining the present visual content and the unsolicited visual content such they do not substantially overlap.

36. An apparatus according to claim 29, wherein the unsolicited content is accompanied by meta-data relating to the intended rendering properties of the unsolicited content.

37. An apparatus according to claim 29, wherein receiving the data packets containing unsolicited content over a logical data channel dedicated to the provision of unsolicited content.

38. An apparatus according to claims 29, wherein the present content is adapted in dependence on the intended position of the received unsolicited graphical content.

39. A non-transitory computer-readable storage medium carrying one or more sequences of one or more instructions which, when executed by one or more processors, cause an apparatus to at least perform the following:
processing at the apparatus data packets containing unsolicited;
causing at least in part processing of the data packets to retrieve the unsolicited content there from; and
determining to combine or replace or modify a content that is presently being reproduced by the apparatus with the unsolicited content.
